(19) United States
(12) Patent Application Publication
(10) Pub. No.: US 2025/0191848 A1
(43) Pub. Date: Jun. 12, 2025

(54) METHOD OF PRODUCING PHOTOELECTRIC CONVERSION ELEMENT

(71) Applicant: Sharp Display Technology Corporation, Kameyama City (JP)

(72) Inventors: Nobuhiro WAKA, Kameyama City (JP); Hirokazu ICHINOSE, Kameyama City (JP); Makoto NISHIUCHI, Kameyama City (JP); Tokio TAGUCHI, Kameyama City (JP)

(21) Appl. No.: 18/932,850

(22) Filed: Oct. 31, 2024

(30) Foreign Application Priority Data
Dec. 6, 2023 (JP) 2023-205876

(51) Int. Cl. H01G 9/00; H01G 9/20

(52) U.S. Cl. CPC H01G 9/0036; H01G 9/2077

(57) ABSTRACT

A method of producing a photoelectric conversion component includes forming a porous semiconductor layer on a first substrate, disposing dye solution including a dye with printing on the first substrate or a second substrate, s and bonding the first substrate and the second substrate.

### CROSS REFERENCE TO RELATED APPLICATION

This application claims priority from Japanese Patent Application No. 2023-205876 filed on Dec. 6, 2023. The entire contents of the priority application are incorporated herein by reference.

### TECHNICAL FIELD

The present technology described herein relates to a method of producing a photoelectric conversion element.

### BACKGROUND

There has been known a dye adsorption device that is used for producing a dye-sensitized solar cell, which is one kind of photoelectric conversion elements. One example of such a dye adsorption device is for adsorbing a dye in a porous semiconductor layer on an unprocessed surface of a substrate. Such a dye adsorption device includes a nozzle, a dye solution drop-coating unit, a solvent evaporating/removing unit, and a rinsing unit. Dye solution obtained by dissolving the dye into a predefined solvent is ejected from the nozzle. In the dye solution drop-coating unit, the dye solution is dropped on the porous semiconductor layer on the substrate and the porous semiconductor layer is coated with the dye solution. In the solvent evaporating/removing unit, the solvent is evaporated and removed from the dye solution disposed on the semiconductor layer on the substrate. In the rinsing unit, unnecessary or extra dye attached to the surface of the semiconductor layer on the substrate is rinsed and removed.

When producing dye-sensitized solar cells with using the dye adsorption device, the dye solution is dropped on the porous semiconductor layer on the substrate with coating via the nozzle of the dye solution drop-coating unit. Therefore, the semiconductor layer includes portions on which the dye solution is dropped and portions on which the dye solution is not dropped. This may cause unevenness in density of the dye. If such unevenness in density of the dye is caused in the semiconductor layer, the photoelectric conversion efficiency may be lowered and quality of outer appearance may be lowered.

### SUMMARY

The technology described herein was made in view of the above circumstances. An object is to reduce unevenness in density of a dye.

(1) A method of producing a photoelectric conversion component according to the technology described herein includes forming a porous semiconductor layer on a first substrate, disposing dye solution including a dye with printing on the first substrate or a second substrate, and bonding the first substrate and the second substrate.

(2) The method may further include, in addition to (1), placing a screen plate having holes on the first substrate or the second substrate, supplying the dye solution on the screen plate, spreading the dye solution supplied on the screen plate with a squeegee.

(3) The method may further include, in addition to one of (1) and (2), disposing sealing material with coating on one of the first substrate and the second substrate on which the dye solution is not disposed with printing such that the sealing material has a loop shape, and supplying an electrolyte in an area surrounded by the sealing material.

(4) In the method, in addition to any one of (1) to (3), in the disposing, the dye solution may be disposed with printing on the second substrate.

(5) The method may further include, in addition to (4), disposing sealing material with coating on the first substrate such that the sealing material has a loop shape, and supplying an electrolyte in an area surrounded by the sealing material. In the disposing, the dye solution may be disposed with printing on the second substrate such that printed sections on which the dye solution is disposed and non-printed sections on which the dye solution is not disposed are alternately arranged in a surface area of the second substrate.

(6) In the method, in addition to (5), in the disposing, the dye solution may be disposed with printing on the second substrate such that each of the printed sections and the non-printed sections is formed in a band shape extending in one direction.

(7) In the method, in addition to (5), in the disposing, the dye solution may be disposed with printing on the second substrate such that the printed sections are arranged in a zig-zag pattern and the non-printed sections are arranged in a zig-zag pattern.

(8) In the method, in addition to any one of (1) to (3), in the disposing, the dye solution may be disposed with printing on the first substrate.

According to the technology described herein, unevenness in density of a dye can be reduced.

### BRIEF DESCRIPTION OF THE DRAWINGS

FIG. 1 is a plan view of a dye-sensitized solar battery according to a first embodiment.

FIG. 2 is a cross-sectional view of the dye-sensitized solar battery according to the first embodiment.

FIG. 3 is a flowchart illustrating processes of a method of producing the dye-sensitized solar battery according to the first embodiment.

FIG. 4 is a cross-sectional view of a first substrate after a first electrode forming process and a porous semiconductor layer forming process included in the method of producing the dye-sensitized solar battery according to the first embodiment.

FIG. 5 is a cross-sectional view of the first substrate after a sealing material coating process and an electrolyte dropping process included in the method of producing the dye-sensitized solar battery according to the first embodiment.

FIG. 6 is a cross-sectional view of a screen printing device and a second substrate on which a screen plate is disposed in a dye solution printing process after a second electrode forming process and a catalyst layer forming process included in the method of producing the dye-sensitized solar battery according to the first embodiment.

FIG. 7 is a plan view of the screen plate used in the dye solution printing process included in the method of producing the dye-sensitized solar battery according to the first embodiment.

FIG. 8 is a cross-sectional view of the screen printing device and the second substrate on which dye solution is disposed with printing in the dye solution printing process included in the method of producing the dye-sensitized solar battery according to the first embodiment.

FIG. 9 is a cross-sectional view of the second substrate after a drying process included in the method of producing the dye-sensitized solar battery according to the first embodiment.

FIG. 10 is a cross-sectional view of the first substrate and the second substrate before a bonding process included in the method of producing the dye-sensitized solar battery according to the first embodiment.

FIG. 11 is a flowchart illustrating processes of a method of producing the dye-sensitized solar battery according to a second embodiment.

FIG. 12 is a cross-sectional view of a second substrate after a second electrode forming process and a catalyst layer forming process included in the method of producing the dye-sensitized solar battery according to the second embodiment.

FIG. 13 is a cross-sectional view of the second substrate after a sealing material coating process and an electrolyte dropping process included in the method of producing the dye-sensitized solar battery according to the second embodiment.

FIG. 14 is a cross-sectional view of a screen printing device and a first substrate on which a screen plate is disposed in the dye solution printing process after a first electrode forming process and a porous semiconductor layer forming process included in the method of producing the dye-sensitized solar battery according to the second embodiment.

FIG. 15 is a cross-sectional view of a screen printing device and a first substrate on which dye solution is disposed with printing in the dye solution printing process included in the method of producing the dye-sensitized solar battery according to the second embodiment.

FIG. 16 is a cross-sectional view of the first substrate after a drying process included in the method of producing the dye-sensitized solar battery according to the second embodiment.

FIG. 17 is a cross-sectional view of the first substrate and the second substrate before a bonding process included in the method of producing the dye-sensitized solar battery according to the second embodiment.

FIG. 18 is a plan view of a screen plate used in a dye solution printing process included in the method of producing the dye-sensitized solar battery according to a third embodiment.

FIG. 19 is a cross-sectional view of a screen printing device and a second substrate on which a screen plate is disposed in a dye solution printing process after a second electrode forming process and a catalyst layer forming process included in the method of producing the dye-sensitized solar battery according to the third embodiment.

FIG. 20 is a cross-sectional view of the screen printing device and the second substrate on which dye solution is disposed with printing in the dye solution printing process included in the method of producing the dye-sensitized solar battery according to the third embodiment.

FIG. 21 is a plan view of the second substrate on which dye solution is disposed with printing through the dye solution printing process included in the method of producing the dye-sensitized solar battery according to the third embodiment.

FIG. 22 is a cross-sectional view of the second substrate after a drying process included in the method of producing the dye-sensitized solar battery according to the third embodiment.

FIG. 23 is a cross-sectional view of a first substrate and the second substrate before a bonding process included in the method of producing the dye-sensitized solar battery according to the third embodiment.

FIG. 24 is a plan view of a screen plate used in a dye solution printing process included in the method of producing the dye-sensitized solar battery according to a fourth embodiment.

FIG. 25 is a plan view of the second substrate on which dye solution is disposed with printing through the dye solution printing process included in the method of producing the dye-sensitized solar battery according to the fourth embodiment.

### DETAILED DESCRIPTION

### First Embodiment

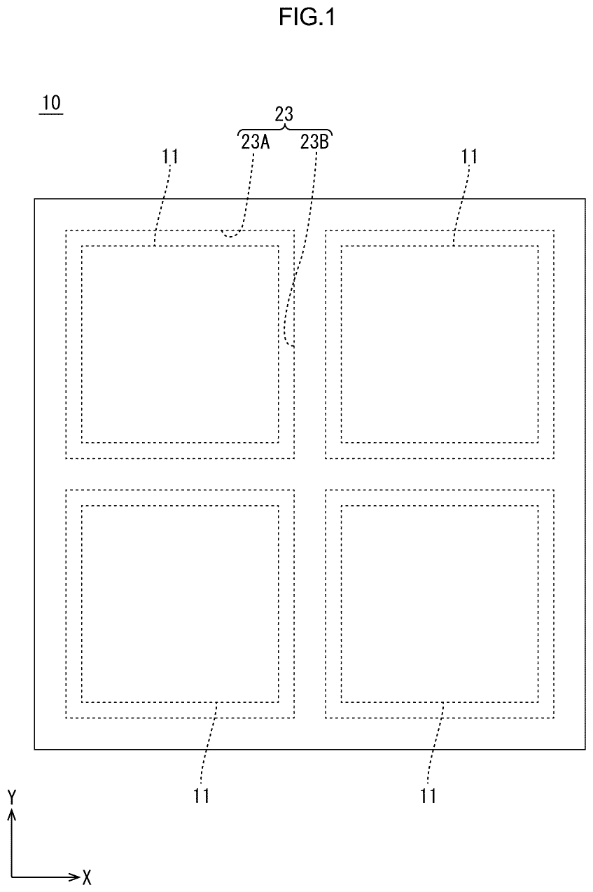

A first embodiment will be described with reference to FIGS. 1 to 10. In this embodiment section, a dye-sensitized solar battery 10 (a photoelectric conversion element) and a method of producing the dye-sensitized solar battery 10 will be described. X-axes, Y-axes, and Z-axes may be present in the drawings. The axes in each drawing correspond to the respective axes in other drawings.

As illustrated in FIG. 1, the dye-sensitized solar battery 10 includes four cells 11 (a battery cell). The dye-sensitized solar battery 10 includes the cells 11 that are connected in series or parallel according to the required output voltage. The dye-sensitized solar battery 10 includes electrodes and wires for connecting the cells 11.

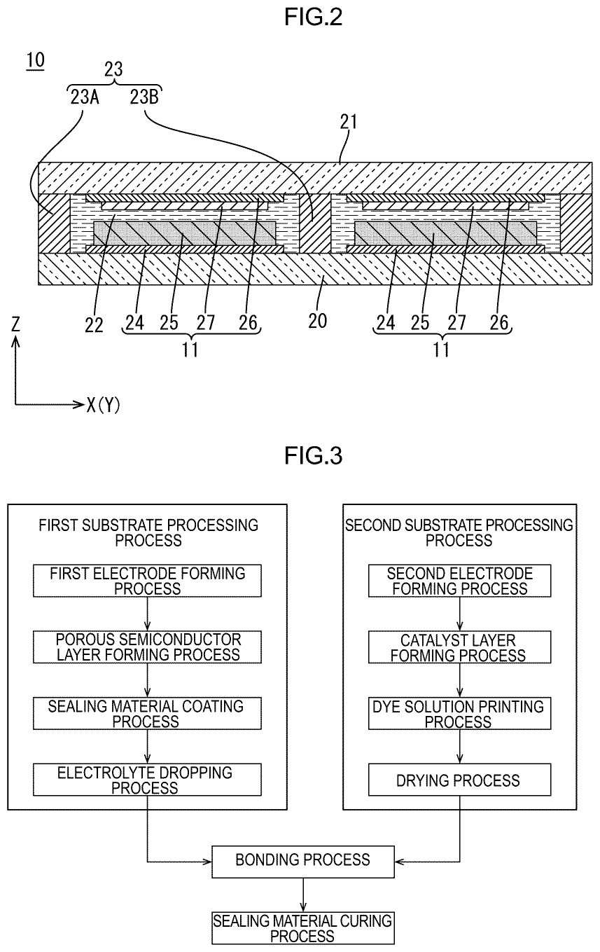

As illustrated in FIG. 2, the dye-sensitized solar battery s a first substrate 20 (a semiconductor substrate, a first support member) and a second substrate 21 (an opposed substrate, a second support member) that are bonded. The first substrate 20 and the second substrate 21 are made of glass material or synthetic resin material and have transmissive properties and insulating properties. An electrolyte 22 and a sealing portion 23 for sealing the electrolyte 22 are between the first substrate 20 and the second substrate 21. The electrolyte 22 will be described in detail.

As illustrated in FIG. 1, the sealing portion 23 is formed in a loop shape and surrounds each cell 11. The sealing portion 23 is made of sealing material 31 (refer to FIG. 5). Examples of the sealing material 31 include UV curable resin material (photocurable resin material). The sealing portion 23 has a grid plan view shape. Specifically, the sealing portion 23 includes a frame portion 23A and a cross portion 23B (a dividing portion). The frame portion 23A overlaps outer edge portions of the first substrate 20 and the second substrate 21 and has a frame plan view shape. The cross portion 23B overlaps middle portions of the first substrate 20 and the second substrate 21 with respect to the X-axis direction and the Y-axis direction and has a cross plan view shape. The frame portion 23A collectively surrounds all the cells 11. The cross portion 23B defines each of the cells 11 that are adjacent to each other with respect to the X-axis direction and the Y-axis direction.

As illustrated in FIG. 2, the cell 11 includes a first electrode 24, a photoelectric conversion layer portion 25, a second electrode 26 (an opposed electrode), and a catalyst layer portion 27. The first electrode 24 and the photoelectric conversion layer portion 25 are disposed on an inner surface side of the first substrate 20 opposite the second substrate 21. The first electrode 24 is disposed on an inner surface of the first substrate 20. The photoelectric conversion layer portion 25 is disposed on the first electrode 24. Several sets (four sets in this embodiment) of the first electrode 24 and the photoelectric conversion layer portion 25, which are overlapped with each other, are arranged in a grid in a plan view on the inner surface of the first substrate 20. The cross portion 23B of the sealing portion 23 defines a border between the two sets of the first electrode 24 and the photoelectric conversion layer portion 25 that are adjacent to each other in the X-axis direction and a border between the two sets of the first electrode 24 and the photoelectric conversion layer portion 25 that are adjacent to each other in the Y-axis direction.

The first electrode 24 is made of material that can be generally used for a solar battery and has electrically conductive properties. As the material used for the first electrode 24, at least one selected from the group consisting of indium tin oxide (ITO), tin oxide (SnO₂), fluorine doped tin oxide (FTO), zinc oxide (ZnO), and tantalum or niobium doped titanium oxide can be used.

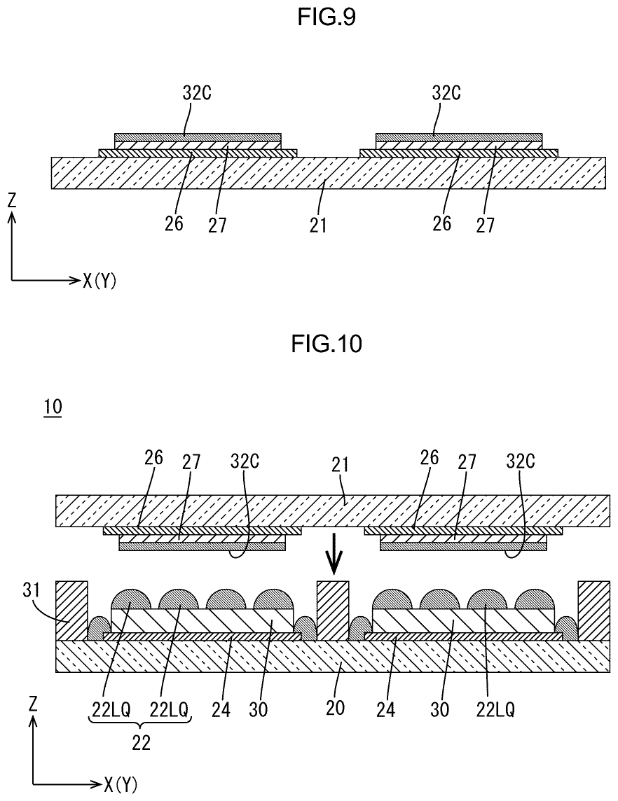

The photoelectric conversion layer portion 25 includes a porous semiconductor and a dye 32C (photosensitizer) adsorbed on the porous semiconductor (refer to FIG. 9). The photoelectric conversion layer portion 25 illustrated in FIG. 2 does not contain the dye 32C. Therefore, the cross section of the photoelectric conversion layer portion 25 is illustrated with a shading in FIG. 2. The semiconductors of the porous semiconductor are not particularly limited as long as they include porous semiconductor that is commonly used for the photoelectric conversion material in the technical filed of the solar battery. As the porous semiconductor, a semiconductor compound including at least one kind selected from the group consisting of titanium oxide, zinc oxide, tin oxide, iron oxide, niobium oxide, cerium oxide, tungsten oxide, barium titanate, strontium titanate, cadmium oxide, lead sulfide, zinc sulfide, indium phosphide, CuInS₂, CuAlO₂, and SrCu₂O can be used. Particularly, to improve stability and safety, the material including titanium oxide may be preferably used for the porous semiconductor. The porous semiconductor may be made of fine particles of titanium oxide having a particle size within a predefined range.

As the dye included in the photoelectric conversion layer portion 25, one kind or two or more kinds of various kinds of organic dyes or metal complex dyes having absorption bands in a visible light range or an infrared range can be used. As an organic dye, at least one kind selected from the group consisting of azo dyes, quinone dyes, quinoneimine dyes, quinacridone dyes, squarylium dyes, cyanine dyes, merocyanine dyes, triphenylmethane dyes, xanthene dyes, porphyrin dyes, perylene dyes, indigo dyes, and naphthalocyanine dyes can be used. The absorption coefficient of the organic dyes is generally greater than that of the metal complex dyes. The metal complex dyes are obtained by bonding of molecules to transition metal through coordinate covalent bond. The metal complex dyes may be obtained by bonding of metal to molecules through coordinate covalent bond. As the molecules, molecules including at least one kind selected from the group consisting of porphyrin dyes, phthalocyanine dyes, naphthalocyanine dyes, and ruthenium dyes can be used. As the metal, at least one kind selected from the group consisting of copper (Cu), nickel (Ni), iron (Fe), cobalt (Co), vanadium (V), tin (Sn), silicon (Si), titanium (Ti), germanium (Ge), chromium (Cr), zinc (Zn), ruthenium (Ru), magnesium (Mg), aluminum (Al), lead (Pb), manganese (Mn), indium (In), molybdenum (Mo), yttrium (Y), zirconium (Zr), niobium (Nb), antimony (Sb), lanthan (La), tungsten (W), platinum (Pt), tantalum (Ta), iridium (Ir), palladium (Pd), osmium (Os), gallium (Ga), terbium (Tb), europium (Eu), rubidium (Rb), bismuth (Bi), selenium (Se), arsenic (As), scandium (Sc), silver (Ag), cadmium (Cd), hafnium (Hf), rhenium (Re), gold (Au), actinium (Ac), technetium (Tc), tellurium (Te), and rhodium (Rh) can be used. Metal complex dyes obtained by bonding of metal to phthalocyanine dyes or ruthenium dyes through coordinate covalent bond are preferably used. Ruthenium metal complex dyes are particularly preferable.

The second electrode 26 and the catalyst layer portion 27 of the cell 11 are disposed on an inner surface side of the second substrate 21 opposite the first substrate 20. The second electrode 26 is disposed on an inner surface of the second substrate 21. The catalyst layer portion 27 is disposed on the second electrode 26. Several sets (four sets in this embodiment) of the second electrodes 26 and the catalyst layer portion 27, which are overlapped with each other, are arranged in a grid in a plan view on the inner surface of the second substrate 21. The cross portion 23B of the sealing portion 23 defines a border between the two sets of the second electrode 26 and the catalyst layer portion 27 that are adjacent to each other in the X-axis direction and a border between the two sets of the second electrode 26 and the catalyst layer portion 27 that are adjacent to each other in the Y-axis direction.

The second electrode 26 is made of material that can be generally used for a solar battery and has electrically conductive properties. The second electrode 26 may be made of the same material as that of the first electrode 24 or may be made of material different from that of the first electrode 24. The material of the second electrode 26 may not have light transmissive properties. The second electrode 26 may be made of metal material including at least one kind selected from the group consisting of titanium, tungsten, gold, silver, copper, aluminum, and nickel. The second electrode 26 may be made of conductive carbon material such as carbon black and ketjenblack. With the second electrode 26 being made of the conductive carbon material, the second electrode 26 and the catalyst layer portion 27 may be configured as one component. The catalyst layer portion 27 is disposed between the electrolyte 22 and the second electrode 26 and for activating oxidation-reduction reaction of the electrolyte 22. The catalyst layer portion 27 may be made of at least one kind selected from the group consisting of platinum, graphite, carbon black, ketjenblack, carbon nanotubes, graphene, and fullerene.

The electrolyte 22 will be described. The electrolyte 22 of this embodiment is liquid containing redox species and is electrolyte solution (liquid electrolyte). The electrolyte 22 includes I⁻ and I₃⁻ as the redox species. In addition to I⁻/I₃⁻ type, Br²⁻/Br³⁻ type, Fe²⁺/Fe³⁺ type, and quinone/hydroquinone type may be used for the electrolyte 22. The electrolyte 22 includes a solvent (an organic solvent) in addition to the redox species. Examples of the solvent included in the electrolyte 22 include acetonitrile, ethanol, propanol, t-butanol, ethylene carbonate, and methoxy acetonitrile. As illustrated in FIG. 2, the electrolyte 22 is sealed in a space that is defined by the sealing portion 23 for every cell 11. With ions included in the electrolyte 22 moving between the photoelectric conversion layer portion 25 and the second electrode 26 of each cell 11, electrons are transferred.

Next, operations of the dye-sensitized solar battery 10 will be described. With light such as sunlight being supplied to the dye-sensitized solar battery 10, a dye included in the photoelectric conversion layer portion 25 is excited by the light and the state of electrons of the dye changes from an original state to an excited state. The excited electrons of the dye are injected into a conduction band of the semiconductor (for example, titanium oxide) of the photoelectric conversion layer portion 25 and move from the first electrode 24 to the second electrode 26 via an external circuit. The dye that loses the electrons and is oxidized receives an electron from the electrolyte 22 and reduction occurs and the state of the dye returns to the original state. The electrolyte 22 loses electrons and are oxidized (for example, the electrolyte 22 of I⁻/I₃⁻ type becomes I₃⁻). On the other hand, the electrons that move to the second electrode 26 move to the electrolyte 22 via the catalyst layer portion 27. The electrolyte 22 receives electrons and become in the reduction state (for example, the electrolyte 22 of I⁻/I₃⁻ type becomes I⁻). Such a cycle is repeatedly performed and light energy is converted into electrical energy.

Next, a method of producing the dye-sensitized solar battery 10 will be described. As illustrated in FIG. 3, the method of producing the dye-sensitized solar battery 10 includes a first substrate processing process in which certain structures are disposed on the first substrate 20, a second substrate processing process in which certain structures are disposed on the second substrate 21, a bonding process in which the first substrate 20 and the second substrate 21 are bonded, and a sealing material curing process in which the sealing material 31 is cured.

As illustrated in FIG. 3, the first substrate processing process includes a first electrode forming process in which the first electrode 24 is formed on the first substrate 20, a porous semiconductor layer forming process in which a porous semiconductor layer portion 30 is formed on the first substrate 20, a sealing material coating process in which the sealing material 31 (material of the sealing portion 23) is disposed on the first substrate 20 with coating, and an electrolyte dropping process in which droplets 22LQ of the electrolyte 22 are dropped on the first substrate 20. The second substrate processing process includes a second electrode forming process in which the second electrode 26 is formed on the second substrate 21, a catalyst layer forming process in which the catalyst layer portion 27 is formed on the second substrate 21, a dye solution printing process in which printing is performed on the second substrate 21 with a dye solution 32 containing a dye 32C, and a drying process in which the dye solution 32 is dried. The first substrate processing process and the second substrate processing process include a process of forming electrodes and traces on the first substrate 20 and the second substrate 21 for connecting the cells 11.

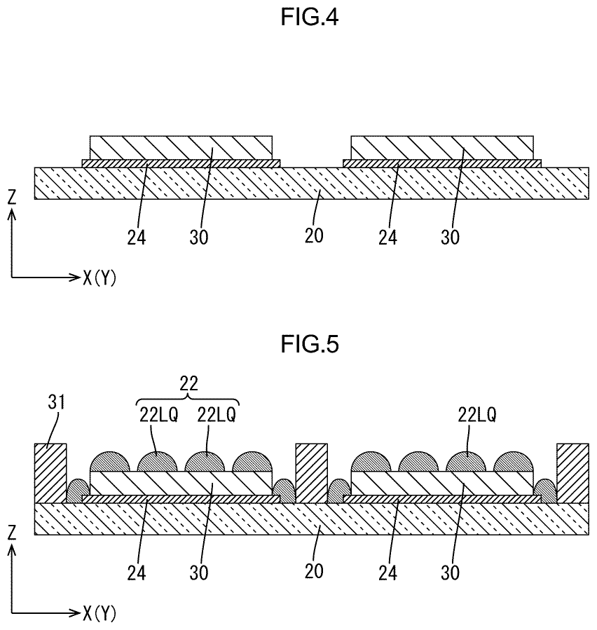

In the first electrode forming process of the first substrate processing process, as illustrated in FIG. 4, the first electrode 24 is formed on the surface of the first substrate 20 with sputtering or spraying. In the porous semiconductor layer forming process, suspension containing semiconductor fine particles, which are material of the porous semiconductor, is disposed on the first electrode 24 with coating and is dried or fired and the porous semiconductor layer portion 30 is formed on the first electrode 24. The porous semiconductor layer portion 30 illustrated in FIG. 4 does not include the dye 32C. Therefore, the cross-section of the porous semiconductor layer portion 30 is illustrated with no shading in FIG. 4. Specifically, suspension is obtained by mixing the semiconductor fine particles and solvent. The obtained suspension is disposed on the first electrode 24 with a known method such as doctor blade coating, squeegee coating, spin coating, and screen printing. The temperature, time, and atmosphere necessary for drying or firing of the suspension disposed on the first electrode 24 may be determined as appropriate according to the kind of the semiconductor fine particles. For example, drying or firing of the suspension may be performed under an atmosphere or an inert gas atmosphere and at a temperature within the range from 50° C. to 800° C. for 10 seconds or more and twelve hours or less. Such drying or firing of the suspension may be performed once at a certain temperature or twice or more at different temperatures.

As illustrated in FIG. 5, in the sealing material coating process, the sealing material 31, which is material of the sealing portion 23, is supplied on the surface of the first substrate 20 with coating by a dispenser device. Specifically, with the sealing material coating process being performed, the sealing material 31 is supplied on the surface of the first substrate 20 to surround each of the sets of the first electrode 24 and the porous semiconductor layer portion 30 and formed in a loop shape. The area in which the sealing material 31 is supplied substantially matches the area in which the sealing portion 23 is disposed as illustrated in FIG. 1. After the sealing material coating process, a temporal curing process may be performed. In the temporal curing process, the sealing material 31 is irradiated with ultraviolet rays such that the sealing material 31 is half-cured. In the electrolyte dropping process, the droplets 22LQ of the electrolyte 22 are dropped on the surface of the first substrate 20 by a dispenser device. A predefined amount of the droplets 22LQ of the electrolyte 22 is dropped on each of the sections of the surface of the first substrate 20. Each of the sections of the first substrate 20 is surrounded by the sealing material 31 of a loop shape.

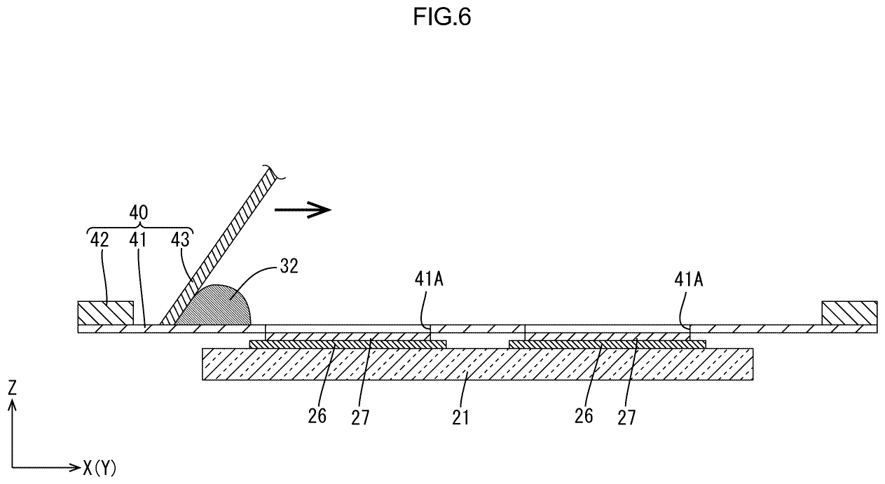

In the second electrode forming process of the second substrate processing process, as illustrated in FIG. 6, the second electrode 26 is formed on the surface of the second substrate 21 with sputtering or spraying. In the catalyst layer forming process, the catalyst layer portion 27 is formed on the second electrode 26 with PVC method, evaporation method, or sputtering method, for example.

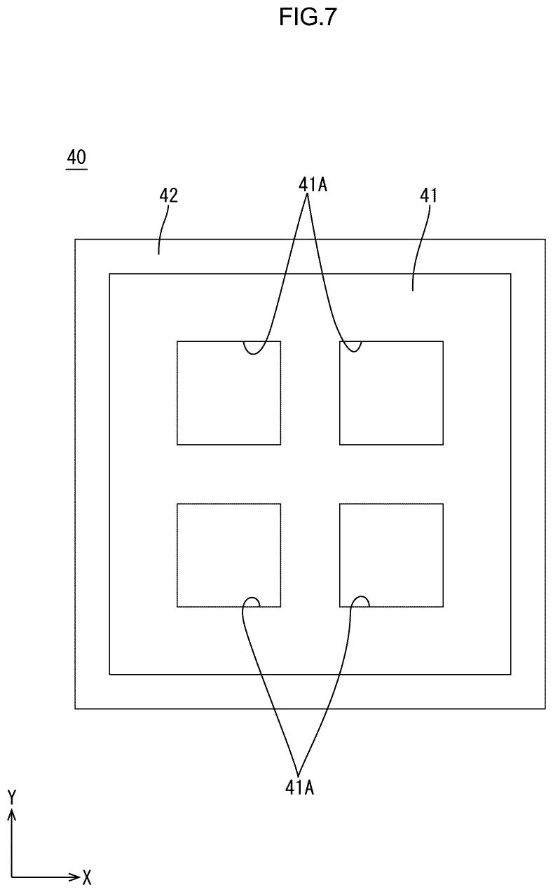

In the dye solution printing process, the dye solution 32 containing dye 32C is supplied on the catalyst layer portion 27 with printing by a screen printing device 40. The dye solution 32 is obtained by dissolving the dye 32C in a solvent so as to have a predetermined density. The dye solution 32 is preferably formed in a paste; however, it is not limited thereto. A configuration of the screen printing device 40 will be described with reference to FIGS. 6 and 7. The screen printing device 40 at least includes a screen plate 41, a frame 42 that is attached to an outer peripheral portion of the screen plate 41, and a squeegee 43 that is movable on the screen plate 41. The screen plate 41 has a surface that extends parallel to the surface of the second substrate 21 that is a target printing object. The surface of the screen plate 41 is opposite the surface of the second substrate 21 with a distance therebetween. The screen printing device 40 further includes a stage on which the second substrate 21 is placed. The screen plate 41 has a plan view size greater than that of the second substrate 21. The screen plate 41 includes holes 41A in portions overlapping the catalyst layer portions 27 of the second substrate 21, respectively. The four holes 41A are formed in the surface of the screen plate 41 and arranged in a grid. The screen plate 41 is produced by coating a substrate, which is made by knitting thin metal wires in a mesh, with photosensitive emulsion in a solid manner and selectively exposing the photosensitive emulsion with light. The portions of the substrate where the photosensitive emulsion is not exposed to light correspond to the holes 41A.

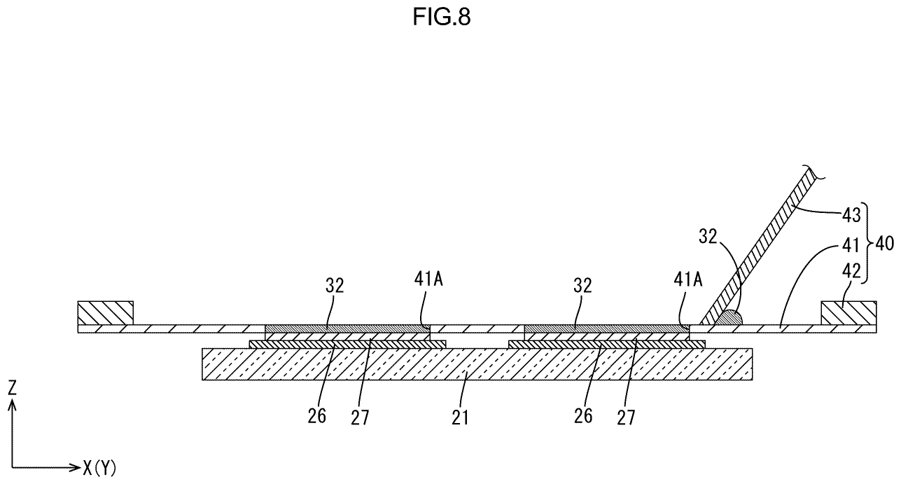

As illustrated in FIG. 6, in the dye solution printing process, the dye solution 32 is supplied on the screen plate 41 that is opposite the surface of the second substrate 21 with a certain distance therebetween. With the squeegee 43 moving along the surface of the screen plate 41, the dye solution 32 spreads over the screen plate 41 as illustrated in FIG. 8. Then, the dye solution 32 is supplied through the holes 41A of the screen plate 41 and disposed with printing on the catalyst layer portions 27 that overlap the holes 41A. The printed dye solution 32 is disposed in a solid manner in an entire area of the catalyst layer portion 27. Namely, in the surface area of the second substrate 21, the printing area in which the dye solution 32 is disposed with printing matches the forming area in which the catalyst layer portion 27 is formed. After forming the dye solution 32 with printing, the second substrate 21 is taken out from the screen printing device 40. Thereafter, in the drying process, as illustrated in FIG. 9, the dye solution 32 disposed on the catalyst layer portion 27 is dried under a predetermined temperature environment for a predetermined time. Through the drying process, the solvent included in the dye solution 32 is evaporated and the dye 32C remains on the catalyst layer portion 27. The dye 32C is on a substantially entire area of the catalyst layer portion 27 in a solid manner.

After performing the first substrate processing process and the second substrate processing process, the bonding process is performed. As illustrated in FIG. 10, in the bonding process, the first substrate 20 having the sealing material 31 thereon is placed on a lower side and the second substrate 21 is disposed opposite and above the first substrate 20. Then, the second substrate 21 is moved closer to the first substrate 20 and the substrates 20, 21 are bonded. According to the bonding, with the sealing material 31 of the first substrate 20 comes in contact with the second substrate 21, a space formed between the first substrate 20 and the second substrate 21 is divided by the sealing material 31. The divided spaces (a space inside each cell 11) are filled with the electrolyte 22. In each of the spaces divided by the sealing material 31, the dye 32C adhering to the catalyst layer portion 27 of the second substrate 21 is dissolved in the solvent of the electrolyte 22 and dispersed in the solvent and gradually adsorbed on the surface of the porous semiconductor layer portion 30. Thus, the photoelectric conversion layer portion 25 is formed. Thereafter, with the sealing material curing process being performed, a light source, which emits ultraviolet rays, supplies ultraviolet rays having predefined emission intensity to the sealing material 31. As illustrated in FIG. 2, the sealing material 31 that is supplied with ultraviolet rays is completely cured and turned to be the sealing portion 23. The electrolyte 22 in each cell 11 is sealed with the cured sealing portion 23. Thus, the dye-sensitized solar battery 10 is produced.

As previously described, in this embodiment, in the dye solution printing process of the second substrate processing process, the dye solution 32 including the dye 32C is disposed on the second substrate 21 with screen printing. With the screen printing method, by changing the pattern of the holes 41A in the screen plate 41, the printing area where the dye solution 32 is disposed can be easily adjusted.

Specifically, in this embodiment, the dye solution 32 is disposed with printing on the catalyst layer portion 27 of the second substrate 21 in a solid manner. The dye 32C included in the dye solution 32 disposed on the second substrate 21 is dissolved in the solvent of the electrolyte 22 and dispersed in the solvent in the bonding process. The dye 32C, which is disposed on the catalyst layer portion 27 in a solid manner, is dispersed uniformly in an entire area of the section of the electrolyte 22 overlapping the porous semiconductor layer portion 30. The solvent of the electrolyte 22 enters fine holes on the surface of the porous semiconductor layer portion 30. Therefore, the dye 32C dispersed in the solvent spreads to the inside of the fine holes and is uniformly adsorbed on the inner surfaces of the fine holes.

In the related art, the dye solution is dropped on the semiconductor layer. Therefore, the semiconductor layer includes portions on which the dye solution is dropped and portions on which the dye solution is not dropped and this may cause unevenness in density of the dye. Particularly, the dye having a large molecule size is likely to spread along the vertical direction and less likely to spread along the horizontal direction in the portion of the semiconductor layer where the dye solution is dropped. Therefore, unevenness in density of the dye is clearly recognized. In this embodiment, the dye solution 32 is disposed in a solid manner on the catalyst layer portion 27 of the second substrate 21 with printing. Therefore, the dye 32C included in the dye solution 32 can adhere uniformly to an entire area of the porous semiconductor layer portion 30 that is opposite the catalyst layer portion 27. Accordingly, unevenness in density of the dye 32C is less likely to be caused in the porous semiconductor layer portion 30 and the photoelectric conversion efficiency of the photoelectric conversion layer portion 25 can be increased and quality of outer appearance is improved. In this embodiment, the sealing material coating process and the electrolyte dropping process are included in the first substrate processing process and the dye solution printing process and the drying process are included in the second substrate processing process. Therefore, the sealing material coating process and the electrolyte dropping process can be performed at the same time as the dye solution printing process and the drying process. This can shorten a tact time.

As previously described, according to this embodiment, in the method of producing the dye-sensitized solar battery 10 (the photoelectric conversion element) by bonding the first substrate 20 and the second substrate 21, the porous semiconductor layer portion 30 is formed on the first substrate 20 and the dye solution 32 including the dye 32C is disposed on the first substrate 20 or the second substrate 21 with printing.

The porous semiconductor layer portion 30 is formed on the first substrate 20 and the dye solution 32 is disposed on the first substrate 20 or the second substrate 21 with printing. The dye-sensitized solar battery 10 is produced by bonding the first substrate 20 and the second substrate 21. With the dye solution 32 being disposed on the second substrate 21 with printing as described in this embodiment, the dye 32C is adsorbed on the porous semiconductor layer portion 30 according to the bonding of the first substrate 20 and the second substrate 21. With the dye solution 32 being disposed on the first substrate 20 or the second substrate 21 with printing, the printing area in which the dye solution 32 is disposed can be easily adjusted. Therefore, unevenness in density of the dye is less likely to be caused. This increases photoelectric conversion efficiency and quality of outer appearance is improved.

The screen plate 41 having the holes 41A is disposed on the first substrate 20 or the second substrate 21 and the dye solution 32 is supplied on the screen plate 41 and the dye solution 32 is spread by the squeegee 43. With the dye solution 32 supplied on the screen plate 41 being spread by the squeegee 43, the dye solution 32 is supplied through the hole 41A of the screen plate 41 and disposed on the first substrate 20 or the second substrate 21 with printing. The printing with the dye solution 32 is performed with the screen printing method. Therefore, by changing the pattern of the holes 41A in the screen plate 41, the printing area where the dye solution 32 is disposed can be easily adjusted.

The sealing material 31 is disposed on the first substrate 20, on which the dye solution 32 is not disposed, in a loop shape with coating. The electrolyte 22 is supplied to the area surrounded by the sealing material 31. With the first substrate 20 and the second substrate 21 being bonded, the space between the substrates 20, 21 is filled with the electrolyte 22 and the electrolyte 22 is sealed by the sealing portion 23 made of the sealing material 31. The process in which the dye solution 32 is disposed with printing on the first substrate 20 or the second substrate 21 and the process in which the sealing material 31 is disposed with coating on the first substrate 20, which does not include the dye solution 32, and the electrolyte 22 is supplied can be performed at the same time. This shortens a tact time.

The dye solution 32 is disposed on the second substrate 21 with printing. After forming the porous semiconductor layer portion 30 on the first substrate 20 and disposing the dye solution 32 on the second substrate 21 with printing, the first substrate 20 and the second substrate 21 are bonded. Then, the dye 32C included in the dye solution 32 on the second substrate 21 is adsorbed on the porous semiconductor layer portion 30 that is formed on the first substrate 20.

### Second Embodiment

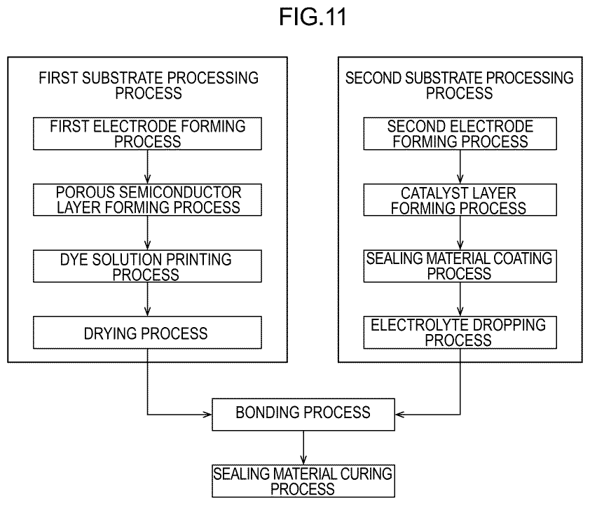

A second embodiment will be described with reference to FIGS. 11 to 17. A method of producing the dye-sensitized solar battery 10 according to this embodiment includes steps that differ from those of the first embodiment. Configurations, operations, and effects similar to those of the first embodiment may not be described.

As illustrated in FIG. 11, in the method of producing the dye-sensitized solar battery 10 according to this embodiment, the first substrate processing process includes the first electrode forming process, the porous semiconductor layer forming process, the dye solution printing process, and the drying process, and the second substrate processing process includes the second electrode forming process, the catalyst layer forming process, the sealing material coating process, and the electrolyte dropping process. The first substrate processing process and the second substrate processing process will be described.

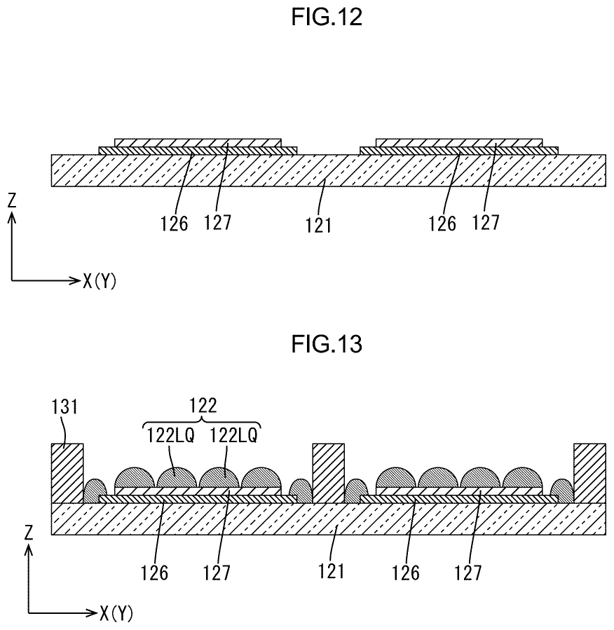

In the second substrate processing process, similar to the first embodiment, with the second electrode forming process and the catalyst layer forming process being performed, as illustrated in FIG. 12, a second electrode 126 and a catalyst layer portion 127 are formed on the surface of a second substrate 121. Thereafter, with the sealing material coating process being performed, as illustrated in FIG. 13, sealing material 131 is supplied on the surface of the second substrate 121 to surround each of the sets of the second electrode 126 and the catalyst layer portion 127 and formed in a loop shape. Then, with the electrolyte dropping process being performed, droplets 122LQ of an electrolyte 122 are dropped on the surface of the second substrate 121. A predefined amount of the droplets 122LQ of the electrolyte 122 is dropped on each of the sections of the surface of the second substrate 121 that is surrounded by the sealing material 131 of a loop shape.

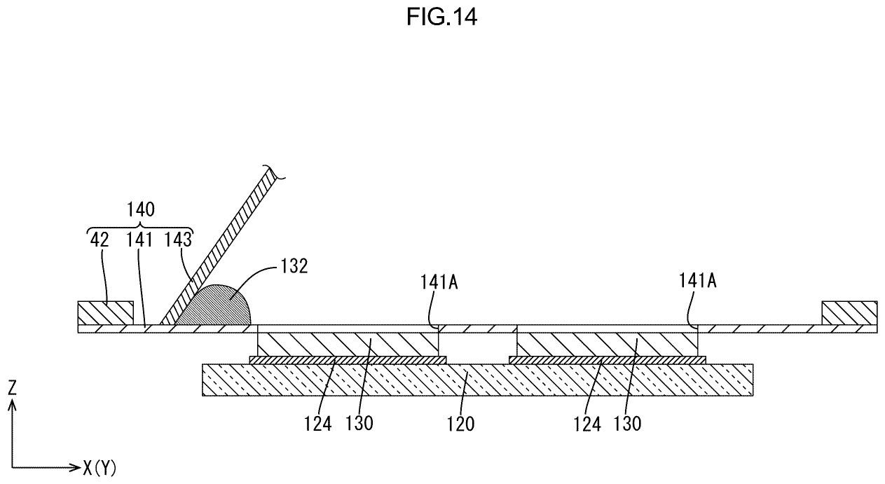

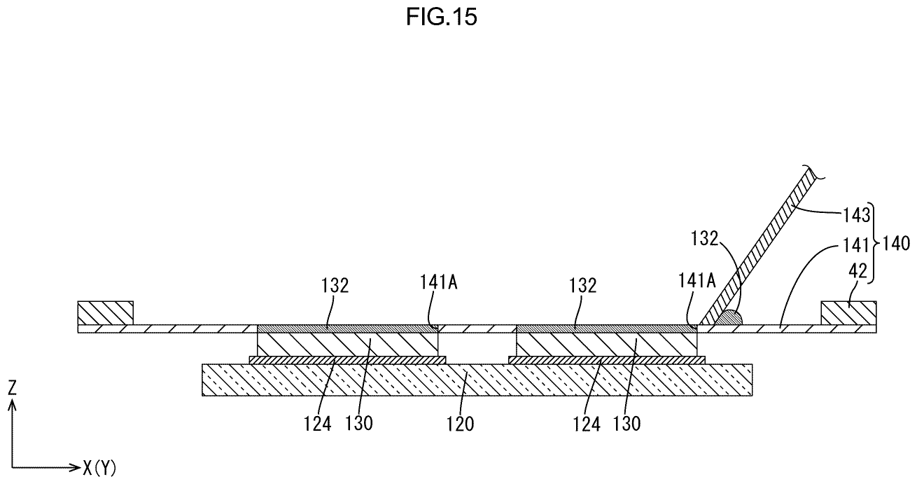

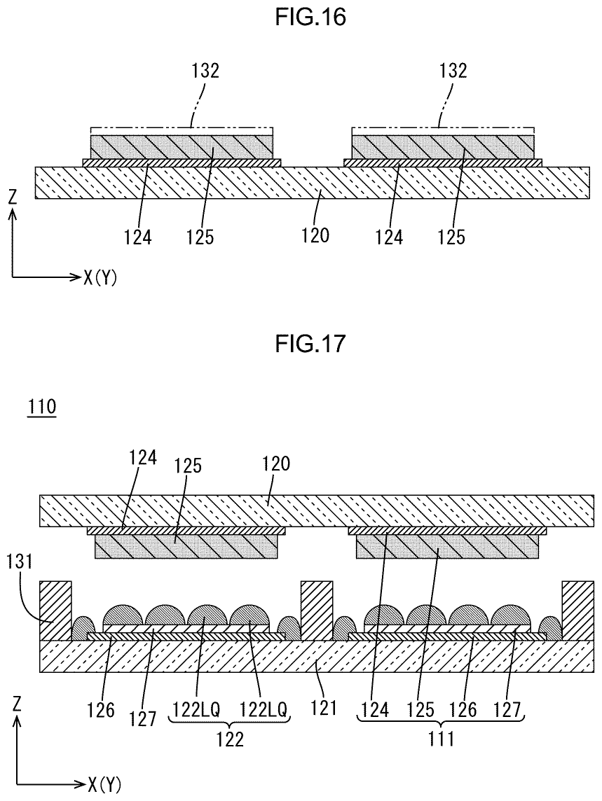

In the first substrate processing process, similar to the first embodiment, with the first electrode forming process and the porous semiconductor layer forming process being performed, as illustrated in FIG. 14, a first electrode 124 and a porous semiconductor layer portion 130 are formed on the surface of a first substrate 120. Then, the dye solution printing process is performed. A screen printing device 140 is used in the dye solution printing process. A screen plate 141 of the screen printing device 140 includes holes 141A in portions overlapping the porous semiconductor layer portions 130 of the first substrate 120, respectively. Four holes 141A are formed in the surface of the screen plate 141 and arranged in a grid in a plan view. In the dye solution printing process, dye solution 132 is supplied on the screen plate 141 that is opposite the surface of the first substrate 120 with a certain distance therebetween. With a squeegee 143 moving along the surface of the screen plate 141, the dye solution 132 spreads over the screen plate 141 as illustrated in FIG. 15. Then, the dye solution 132 is supplied through the holes 141A of the screen plate 141 and disposed with printing on the porous semiconductor layer portions 130 that overlap the holes 141A. The printed dye solution 132 is disposed in a solid manner in an entire area of the porous semiconductor layer portion 130. Namely, in the surface area of the first substrate 120, the printing area in which the dye solution 132 is disposed with printing matches the forming area in which the porous semiconductor layer portion 130 is formed. Thus, the dye solution 132 disposed on the porous semiconductor layer portion 130 enters fine holes on the surface of the porous semiconductor layer portion 130 and this accelerates spreading of the dye 32C included in the dye solution 132 and the dye 32C is gradually adsorbed on the surface of the porous semiconductor layer portion 130. Thereafter, through the drying process, as illustrated in FIG. 16, the solvent included in the dye solution 132 on the porous semiconductor layer portion 130 is evaporated and the dye 32C remains on the surface of the porous semiconductor layer portion 130. Thus, a photoelectric conversion layer portion 125 is formed.

After performing the first substrate processing process and the second substrate processing process as previously described, the bonding process is performed. As illustrated in FIG. 17, in the bonding process, the second substrate 121 having the sealing material 131 thereon is placed on a lower side and the first substrate 120 is disposed opposite and above the second substrate 121. Then, the first substrate 120 is moved closer to the second substrate 121 and the substrates 120, 121 are bonded. According to the bonding, with the sealing material 131 of the second substrate 121 comes in contact with the first substrate 120, a space formed between the first substrate 120 and the second substrate 121 is divided by the sealing material 131. The divided spaces (a space inside each cell 111) are filled with the electrolyte 122. Thereafter, with the sealing material curing process being performed, the sealing material 131 is supplied with ultraviolet rays and the sealing material 131 is completely cured. Thus, the dye-sensitized solar battery 110 is produced.

As previously described, in this embodiment, in the dye solution printing process of the first substrate processing process, the dye solution 132 including the dye 32C is disposed on the first substrate 120 with screen printing. With the screen printing method, by changing the pattern of the holes 141A in the screen plate 141, the printing area where the dye solution 132 is disposed can be easily adjusted. Specifically, the dye solution 132 is disposed with printing on the porous semiconductor layer portion 130 of the first substrate 120 in a solid manner. The dye 32C included in the dye solution 132 disposed on the first substrate 120 is uniformly dispersed in an entire area of the porous semiconductor layer portion 130. The dye solution 132 enters fine holes on the surface of the porous semiconductor layer portion 130. Therefore, the dye 32C included in the dye solution 132 spreads to the inside of the fine holes and are adsorbed on the inner surfaces of the fine holes.

In the related art, the dye solution is dropped on the semiconductor layer. Therefore, the semiconductor layer includes portions on which the dye solution is dropped and portions on which the dye solution is not dropped. This may cause unevenness in density of the dye. Particularly, the dye having a large molecule size is likely to spread along the vertical direction and less likely to spread along the horizontal direction in the portion of the semiconductor layer where the dye solution is dropped. Therefore, unevenness in density of the dye is clearly recognized. In this embodiment, the dye solution 132 is disposed in a solid manner on the porous semiconductor layer portion 130 of the first substrate 120 with printing. Therefore, the dye 32C included in the dye solution 132 can adhere uniformly to an entire area of the porous semiconductor layer portion 130. Accordingly, unevenness in density of the dye 32C is less likely to be caused in the porous semiconductor layer portion 130 and the photoelectric conversion efficiency of the photoelectric conversion layer portion 125 can be increased and quality of outer appearance is improved. In this embodiment, the dye solution printing process and the drying process are included in the first substrate processing process and the sealing material coating process and the electrolyte dropping process are included in the second substrate processing process. Therefore, the dye solution printing process and the drying process can be performed at the same time as the sealing material coating process and the electrolyte dropping process. This can shorten a tact time.

As previously described, according to this embodiment, the dye solution 132 is disposed with printing on the first substrate 120. After the porous semiconductor layer portion 130 is formed on the first substrate 120, the dye solution 132 is disposed on the porous semiconductor layer portion 130 with printing. Then, the dye 32C included in the dye solution 132 is adsorbed on the porous semiconductor layer portion 130. Then, the dye-sensitized solar battery 110 is produced by bonding the first substrate 120 and the second substrate 121.

### Third Embodiment

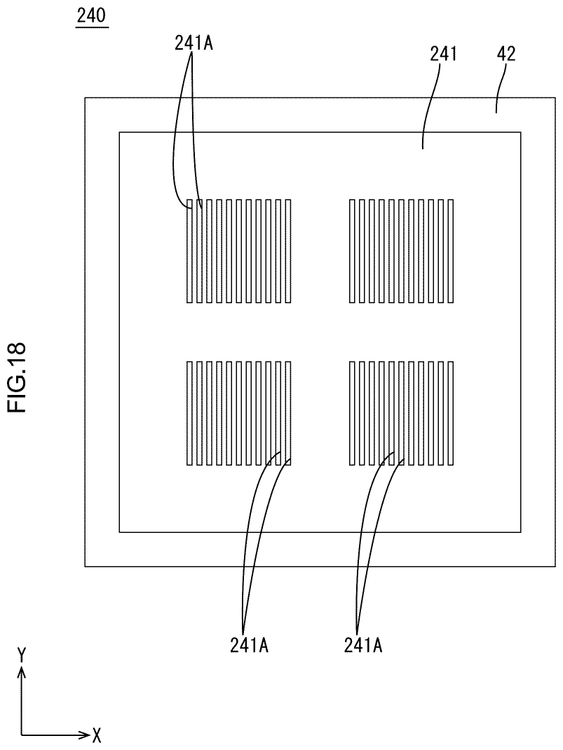

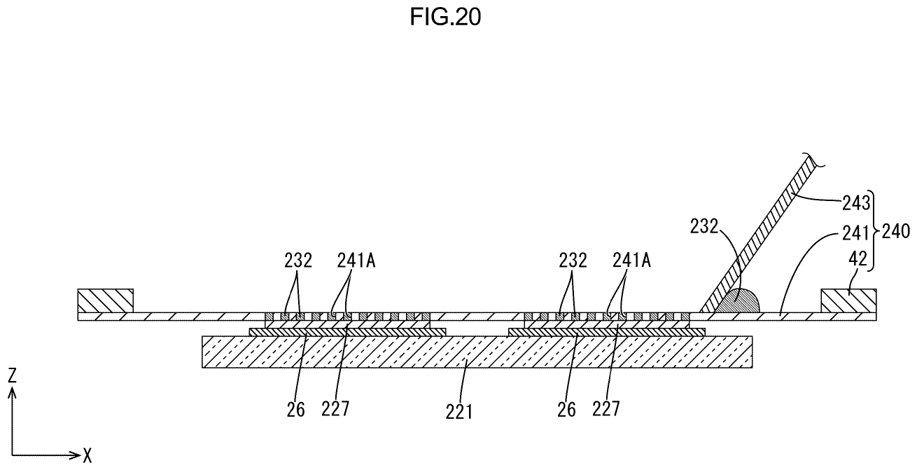

A third embodiment will be described with reference to FIGS. 18 to 23. The third embodiment differs from the first embodiment in the dye solution printing process.

Configurations, operations, and effects similar to those of the first embodiment may not be described.

As illustrated in FIG. 18, a screen plate 241 used in the dye solution printing process of this embodiment includes holes 241A in a portion overlapping each porous semiconductor layer portion 230 of a first substrate 220. Each of the holes 241A has a narrow band shape extending along the Y-axis direction. The holes 241A are arranged at intervals with respect to the X-axis direction in a portion of the screen plate 241 overlapping the porous semiconductor layer portion 230. The hole 241A has a length dimension measured in the Y-axis direction that is substantially same as the dimension of the porous semiconductor layer portion 230 measured in the Y-axis direction. The hole 241A has a width dimension measured in the X-axis direction that is smaller than the dimension of the porous semiconductor layer portion 230 measured in the X-axis direction. The interval between the holes 241A (the interval between the two holes 241A that are adjacent to each other in the X-axis direction) is substantially same as the width dimension of the hole 241A measured in the X-axis direction.

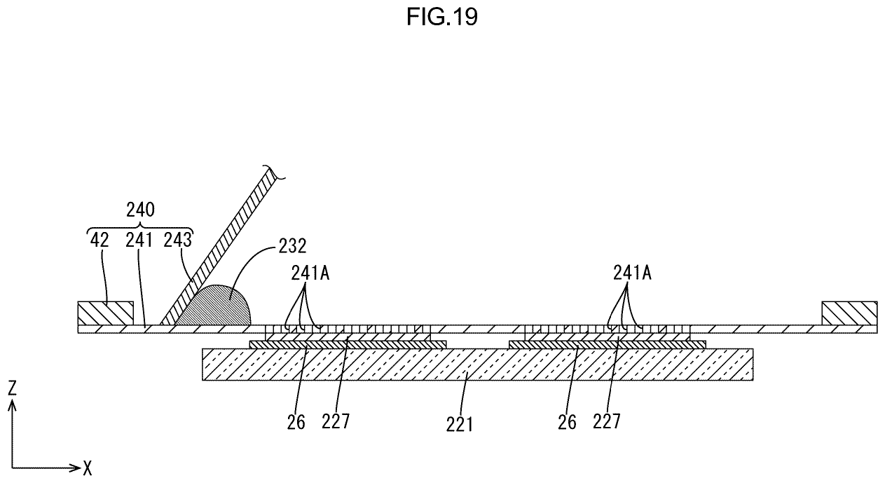

In the dye solution printing process, the dye solution 232 is supplied with printing on the second substrate 221 with using the screen plate 241. Specifically, as illustrated in FIG. 19, the dye solution 232 supplied on the screen plate 241 is spread by a squeegee 243. The squeegee 243 is moved in the direction that matches the width direction of the hole 241A, which is the X-axis direction. The dye solution 232 that is spread by the squeegee 243 is supplied through the holes 241A of the screen plate 241 and disposed on a catalyst layer portion 227 that overlaps the holes 241A with printing.

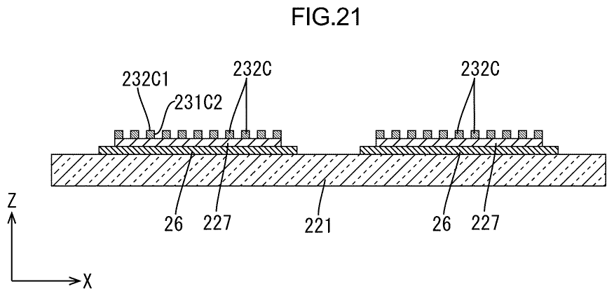

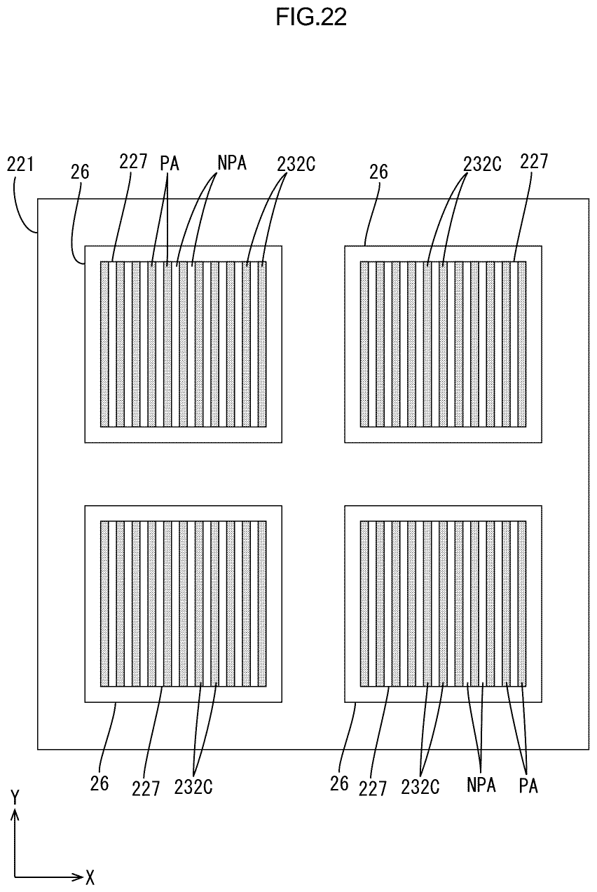

As illustrated in FIG. 21, the printed dye solution 232 is formed in a long and narrow band shape extending in the Y-axis direction (one direction) and the narrow band shaped portions of the dye solution 232 are arranged at intervals along the X-axis direction (a direction crossing the one direction) on the catalyst layer portion 227. Namely, the dye solution 232 is supplied with printing on the surface of the second substrate 221 such that printed sections PA with the printed dye solution 232 and non-printed sections NPA without having the dye solution 232 are alternately arranged in the X-axis direction. In FIG. 22, in the catalyst layer portion 227, the printed sections PA are illustrated with a shading and the non-printed sections NPA are illustrated with an outline in white. The printed sections PA and the non-printed sections NPA have a band shape extending in the Y-axis direction. The printed sections PA are disposed on portions of the catalyst layer portion 227 overlapping the holes 241A of the screen plate 241 in a plan view. The non-printed sections NPA are disposed on portions of the catalyst layer portion 227 not overlapping the holes 241A and next to the holes 241A with respect to the X-axis direction (between every two holes 241A).

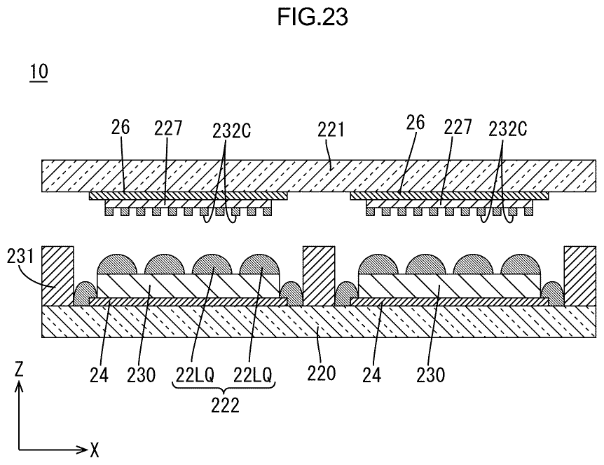

Thereafter, with the drying process being performed, as illustrated in FIG. 22, the solvent included in the dye solution 232 on the catalyst layer portion 227 is evaporated and the dye 232C remains on the catalyst layer portion 227. The dye 232C selectively adheres to the printed sections PA of the catalyst layer portion 227. Then, with the bonding process being performed and the first substrate 220 and the second substrate 221 being bonded, illustrated in FIG. 23, the electrolyte 222 on the first substrate 220 enters the non-printed sections NPA between the printed sections PA on the catalyst layer portion 227. One dye 232C in the printed section PA has a first surface 232C1 that is opposite the porous semiconductor layer portion 230 and a second surface 232C2 that is opposite other dye 232C that is next to the one dye 232C in the X-axis direction. Thus, the electrolyte 222 is contacted with the first surface 232C1 and the second surface 232C2 of the one dye 232C. A contact area of the electrolyte 222 in contact with the dye 232C in the printed section PA is greater than that of the first embodiment. Therefore, the dye 232C can be dissolved easily in the solvent of the electrolyte 222 and dispersed fast in the solvent. Accordingly, the dye 232C dissolved in the electrolyte 222 is dispersed faster into the fine holes of the porous semiconductor layer portion 230 and adsorbed on the inner surfaces of the fine holes faster. Accordingly, unevenness in density of the dye 232C is less likely to be caused in the porous semiconductor layer portion 230 and a tact time can be shortened.

As previously described, according to this embodiment, sealing material 231 is disposed on the first substrate 229 in a loop shape and the electrolyte 222 is supplied to the area surrounded by the sealing material 231. The dye solution 232 is selectively disposed with printing such that the printed sections PA having printed dye solution 232 and the non-printed sections NPA without dye solution 232 are arranged alternately within the surface area of the second substrate 221. After printing with the dye solution 232 on the second substrate 221, the printed sections PA and the non-printed sections NPA are alternately arranged. With the first substrate 220 and the second substrate 221 being bonded, the electrolyte 222 on the first substrate 220 enters the non-printed sections NPA between the printed sections PA on the second substrate 221. This increases the contact area of the electrolyte 222 in contact with the dye 232C (the dye solution 232) in the printed sections PA. Therefore, the dye 232C can be adsorbed on the porous semiconductor layer portion 230 of the first substrate 220 faster. According to the bonding of the first substrate 220 and the second substrate 221, the electrolyte 222 is sealed by the sealing portion 23 made of the sealing material 231.

The dye solution 232 is selectively disposed with printing such that each of the printed sections PA and each of the non-printed sections NPA is formed in a band shape extending in one direction within the surface area of the second substrate 221. After printing with the dye solution 232 on the second substrate 221, the printed sections PA extending in the one direction and the non-printed sections NPA extending in the one direction are alternately arranged in a direction crossing the one direction (a direction crossing an extending direction in which the printed sections PA and the non-printed sections NPA extend). With the first substrate 220 and the second substrate 221 being bonded, the electrolyte 222 on the first substrate 220 enters the non-printed sections NPA having the band shape on the surface of the second substrate 221. This increases the contact area of the electrolyte 222 in contact with the dye 232C (the dye solution 232) in the printed sections PA that are adjacent to the non-printed sections NPA and have a band shape.

### Fourth Embodiment

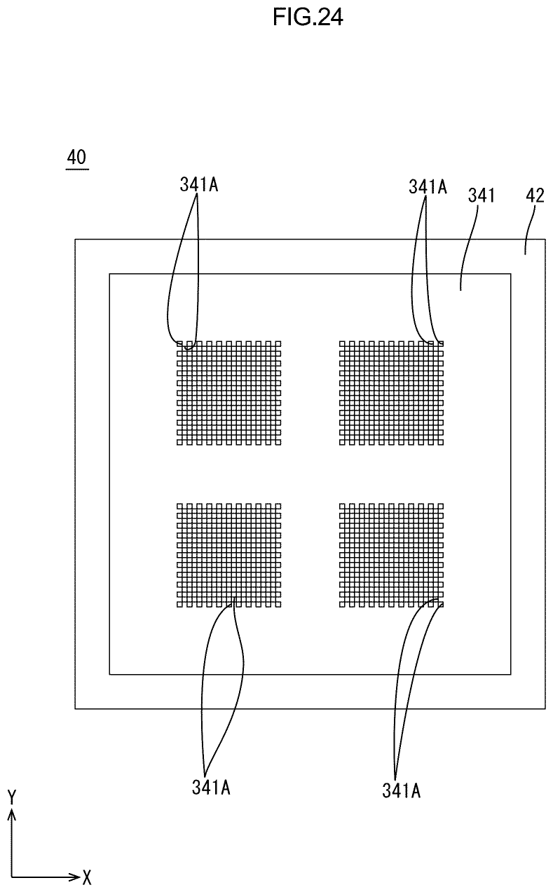

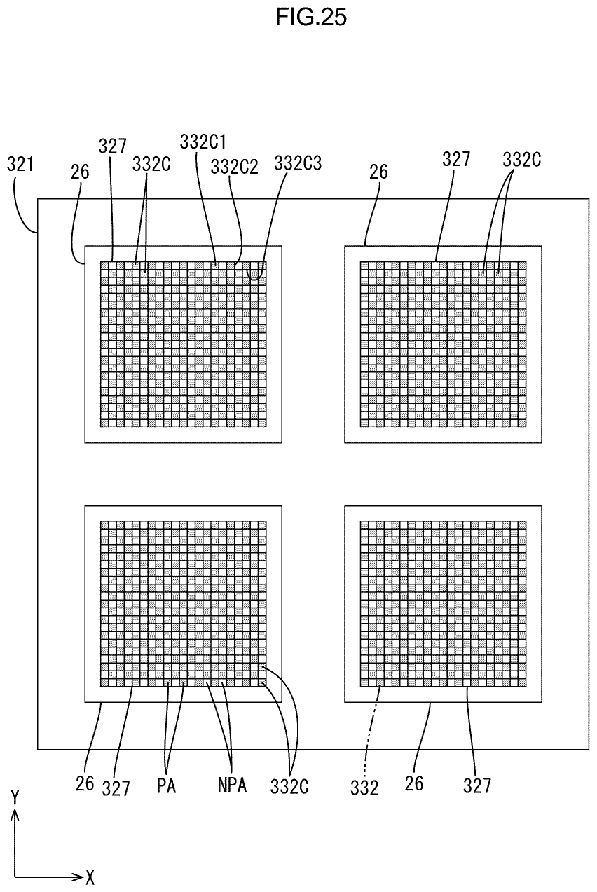

A fourth embodiment be described with reference to FIGS. 24 and 25. The fourth embodiment differs from the third embodiment in the dye solution printing process. Configurations, operations, and effects similar to those of the third embodiment may not be described.

As illustrated in FIG. 24, a screen plate 341 of the screen printing device 40 used in the dye solution printing process of this embodiment includes holes 341A in a portion overlapping each porous semiconductor layer portion 330. The holes 341A are arranged in a zig-zag pattern in a plan view. Specifically, the hole 341A has a quadrangle plan view shape and the holes 341A are arranged at intervals with respect to the X-axis direction and the Y-axis direction. In FIG. 24, the hole 341A has a square plan view shape and the intervals between the holes 341A with respect to the X-axis direction and the Y-axis direction are substantially equal to a side dimension of the hole 341A.

In the dye solution printing process, with the dye solution 332 is disposed with printing on the second substrate 321 with using the screen plate 341 having the above configuration, the printed dye solution 332 is disposed in a pattern illustrated in FIG. 25. More in detail, as illustrated in FIG. 25, with the dye solution 332 being disposed on the second substrate 321 with printing, portions of the dye solution 332 are arranged at intervals with respect to the X-axis direction and the Y-axis direction. Namely, the dye solution 332 is supplied with printing on the surface of the second substrate 321 such that printed sections PA with the printed dye solution 332 are arranged in a zig-zag pattern and non-printed sections NPA without having the dye solution 332 are arranged in a zig-zag pattern. The printed sections PA and the non-printed sections NPA are alternately arranged in the X-axis direction and the Y-axis direction. In FIG. 25, in a catalyst layer portion 327, the printed sections PA are illustrated with a shading and the non-printed sections NPA are illustrated with an outline in white.

With the second substrate 321 having the printed dye solution 332 and the first substrate 20 being bonded, the electrolyte 22 on the first substrate 20 enters the non-printed sections NPA arranged in a zig-zag pattern on the catalyst layer portion 327 (refer to FIG. 23). One dye 332C in the printed section PA has a first surface 332C1 that is opposite the porous semiconductor layer portion 30, a second surface 332C2 that is opposite another dye 332C that is next to the one dye 332C in the X-axis direction, and a third surface that is opposite other dye 332C that is next to the one dye 332C in the Y-axis direction. Thus, the electrolyte 22 is contacted with the first surface 332C1, the second surface 332C2, and the third surface 332C3 of the dye 332C. A contact area of the electrolyte 22 in contact with the dye 332C in the printed section PA is greater than that of the third embodiment. Therefore, the dye 332C can be dissolved more easily in the solvent of the electrolyte 22 and dispersed faster in the solvent. Accordingly, the dye 332C dissolved in the electrolyte 22 is dispersed faster into the fine holes of the porous semiconductor layer portion 30 and adsorbed on the inner surfaces of the fine holes faster. Accordingly, unevenness in density of the dye 332C is less likely to be caused in the porous semiconductor layer portion 30 and a tact time can be shortened.

As previously described, according to this embodiment, the dye solution 332 is supplied with printing on the surface of the second substrate 321 such that the printed sections PA are arranged in a zig-zag pattern and the non-printed sections NPA are arranged in a zig-zag pattern. After the printing on the second substrate 321 with the dye solution 332, the printed sections PA that are arranged in a zig-zag pattern and the non-printed sections NPA that are arranged in a zig-zag pattern. The printed sections PA and the non-printed sections NPA are alternately arranged in one direction and another direction that crosses the one direction. With the first substrate 20 and the second substrate 321 being bonded, the electrolyte 22 on the first substrate 20 enters the non-printed sections NPA that are arranged in a zig-zag pattern on the surface of the second substrate 321. This increases the contact area of the electrolyte 22 in contact with the dye solution 332 on the printed sections PA that are adjacent to the non-printed sections NPA and arranged in a zig-zag pattern.

### Other Embodiments

The technology described herein is not limited to the embodiments described above and illustrated by the drawings. For example, the following embodiments will be included in the technical scope of the present technology.

(1) In the first, third, and fourth embodiments, the sealing material 31, 231 may be disposed with coating on the second substrate 21, 221, 321 on which the dye solution 32, 232, 332 is disposed with printing, and the electrolyte 22, 222 may be dropped on the second substrate 21, 221, 321 on which the dye solution 32, 232, 332 is disposed with printing.

(2) In the second embodiment, the sealing material 131 may be disposed with coating on the first substrate 120 on which the dye solution 132 is disposed with printing and the electrolyte 222 may be dropped on the first substrate 120 on which the dye solution 132 is disposed with printing.

(3) In the first and second embodiments, the size of the hole 41A, 141A of the screen plate 41, 141 (the size of the printed section PA) may be smaller than the size of the catalyst layer portion 27, 127 and the porous semiconductor layer portion 30, 130.

(4) In the third embodiment, the interval between the holes 241A of the screen plate 241 (the interval between the printed sections PA) may be greater than or smaller than the width dimension of the hole 241A.

(5) In the third embodiment, the squeegee 243 may move in the Y-axis direction that is a direction along the length direction of the hole 241A.

(6) In the fourth embodiment, the planar shape of the hole 341A of the screen plate 341 (the planar shape of the printed section PA) may be a rectangular shape. The planar shape of the hole 341A of the screen plate 341 may be a shape other than a quadrangle (for example, a circle, an oval, a triangle, a pentagon, and any other polygons.

(7) In the fourth embodiment, the intervals between the holes 341A of the screen plate 341 with respect to the X-axis direction and the Y-axis direction may differ from the length of one side of the hole 341A.

(8) In the dye solution printing process, the dye solution 32, 132, 232, 332 may be disposed with printing with printing methods other than the screen printing such as relief printing, intaglio printing, lithography, and stencil printing.

(9) The method of forming the first electrode 24, 124 in the first electrode forming process may be altered as appropriate.

(10) The method of forming the second electrode 26, 126 in the second electrode forming process may be altered as appropriate.

(11) The method of forming the porous semiconductor layer portion 30, 130 in the porous semiconductor layer forming process may be altered as appropriate.

(12) The method of disposing the sealing material 31, 131, 231 in the sealing material coating process may be altered as appropriate.

(13) The method of dropping the electrolyte 22, 122, 222 in the electrolyte dropping process may be altered as appropriate. Instead of the electrolyte dropping process, an electrolyte coating process for disposing the electrolyte with coating may be performed. The electrolyte dropping process may be altered as appropriate according to the material used for the electrolyte 22, 122, 222.

(14) The method of forming the catalyst layer portion 27, 127, 227, 327 may be altered.

(15) The method of bonding the first substrate 20, 120, 220 and the second substrate 21, 121, 221, 321 in the bonding process may be altered as appropriate.

(16) The material of the electrodes 24, 26, 125, 126, the catalyst layer portion 27, 127, 227, 327, the porous semiconductor layer portion 30, 130, 230, the sealing material 31, 131, 231, the dye solution 32, 132, 232, 332, and the dye 32C, 232C, 332C may be altered as appropriate.

(17) The substrate 20, 21, 120, 121, 220, 221, 321 may be made of synthetic resin material.

(18) The electrolyte 22, 122, 222 may be a solid (solid electrolyte), a gel (gel electrolyte, molten salt gel electrolyte).

(19) The sealing material 31, 131, 231 may be photocurable resin material that is cured by light having a wavelength other than ultraviolet rays or may be thermosetting resin material. With the material used for the sealing material 31, 131, 231, the sealing material curing process may be altered according to the characteristics of the sealing material 31, 131, 231.

(20) The planar shape of the cell 11 included in the dye-sensitized solar battery 10, 110 may be altered and may be a vertically long rectangle and a laterally long rectangle.

(21) The number of cells 11 included in the dye-sensitized solar batter 10, 110 may be altered. For example, a single cell 11 may be included in the dye-sensitized solar batter 10, 110.

1. A method of producing a photoelectric conversion component comprising:
forming a porous semiconductor layer on a first substrate;
disposing dye solution including a dye with printing on the first substrate or a second substrate; and
bonding the first substrate and the second substrate.

2. The method according to claim 1, further comprising:
placing a screen plate having holes on the first substrate or the second substrate;
supplying the dye solution on the screen plate; and
spreading the dye solution supplied on the screen plate with a squeegee.

3. The method according to claim 1, further comprising:
disposing sealing material with coating on one of the first substrate and the second substrate on which the dye solution is not disposed with printing such that the sealing material has a loop shape; and
supplying an electrolyte in an area surrounded by the sealing material.

4. The method according to claim 1, wherein in the disposing, the dye solution is disposed with printing on the second substrate.

5. The method according to claim 4, further comprising:
disposing sealing material with coating on the first substrate such that the sealing material has a loop shape; and
supplying an electrolyte in an area surrounded by the sealing material, wherein
in the disposing, the dye solution is disposed with printing on the second substrate such that printed sections on which the dye solution is disposed and non-printed sections on which the dye solution is not disposed are alternately arranged in a surface area of the second substrate.

6. The method according to claim 5, wherein in the disposing, the dye solution is disposed with printing on the second substrate such that each of the printed sections and the non-printed sections is formed in a band shape extending in one direction.

7. The method according to claim 5, wherein in the disposing, the dye solution is disposed with printing on the second substrate such that the printed sections are arranged in a zig-zag pattern and the non-printed sections are arranged in a zig-zag pattern.

8. The method according to claim 1, wherein in the disposing, the dye solution is disposed with printing on the first substrate.
